(19) United States
(12) Patent Application Publication
(10) Pub. No.: US 2011/0143212 A1
(43) Pub. Date: Jun. 16, 2011

(54) Non-Aqueous Electrolyte Solution for Rechargeable Lithium Batteries

(76) Inventors: Charles Austen Angell, Mesa, AZ (US); Xiao-Guang Sun, Knoxville, TN (US)

(21) Appl. No.: 12/680,516

(22) PCT Filed: Sep. 26, 2008
(86) PCT No.: PCT/US2008/078008

§ 371 Date: Mar. 26, 2010

Related U.S. Application Data
(60) Provisional application No. 60/976,209, filed on Sep. 28, 2007.

(51) Int. Cl. H01M 10/05; H01M 10/02

(52) U.S. Cl. 429/307; 429/340; 429/306

(57) ABSTRACT

Techniques, systems and materials are described for a rechargeable battery. For example, a battery material can include one or more ionic electrolyte salts. The battery material can also include a non-aqueous electrolyte solvent including one or more non-symmetrical sulfones. Further, the battery material can include one or more additives.

### CROSS-REFERENCE

This Application claims priority under 35 U.S.C. §119(e) to U.S. Provisional Application Ser. No. 60/976,209, filed on Sep. 28, 2007.

### TECHNICAL FIELD

This application relates to rechargeable batteries.

### BACKGROUND

Batteries are commonly used to power many types of motors, lights and electronic devices for use in portable applications. A battery may be rechargeable or disposable (one-shot usage) type. A battery can provide operating power for integrated circuits in portable electronic systems, or provides an electromotive force to drive motors for industrial applications.

### SUMMARY

Techniques, systems and materials are described for a battery electrolyte mixture. In one aspect, a battery electrolyte mixture includes one or more lithium salt electrolytes and one or more sulfones. The mixture also includes one or more additives.

Implementations can optionally include one or more of the following features. The non-aqueous electrolyte solvent can include one or more non-symmetrical, non-cyclic sulfones of a general formula: R1-SO2-R2. The R1 group can include one of a linear alkyl group having 1 to 7 carbon atoms, or a branched alkyl group having 1 to 7 carbon atoms, or a partially fluorinated linear alkyl group having 1 to 7 carbon atoms, or a partially fluorinated branched alkyl group having 1 to 7 carbon atoms, fully fluorinated linear alkyl group having 1 to 7 carbon atoms, or a fully fluorinated branched alkyl group having 1 to 7 carbon atoms. The R2 group, which is different in formulation than the R1 group, can include one of a linear oxygen containing alkyl group having 1 to 7 carbon atoms or a branched oxygen containing alkyl group having 1 to 7 carbon atoms, or a partially fluorinated linear oxygen containing alkyl group having 1 to 7 carbon atoms, or a partially fluorinated branched oxygen containing alkyl group having 1 to 7 carbon atoms, a fully fluorinated linear oxygen containing alkyl group having 1 to 7 carbon atoms, or a fully fluorinated branched oxygen containing alkyl group having 1 to 7 carbon atoms.

Implementations can optionally include one or more of the following features. The one or more additives can be added to improve the solid electrolyte interface (SEI). The one or more additives can include one or more molecular additives. For example, the one or more molecular additives can include at least one of 1,3-Propanesultone (PS), vinylene carbonate (VC), ethylene sulfite (ES), propylene sulfite, fluoroethylene sulfite (FES), [alpha]-bromo-[gamma]-butyrolactone, methyl chloroformate, t-butylene carbonate, 12-crown˜4, carbon dioxide (CO₂), sulfur dioxide (SO₂), sulfur trioxide (SO₃), acid anhydrides, reaction products of carbon disulfide and lithium, and polysulfide. The amount of additives used can vary from a range of 0.1 wt % to 10 wt %. In addition, the one or more additives can include one or more ionic additives. An example of ionic additive can include lithium bis(oxalato)borate (LiBOB) or lithium oxalyldifluoroborate (LiBF₂C₂O₄) or lithium trifluorochloroborate (LiBF₃Cl).

Implementations can optionally include one or more of the following features. The one or more lithium salt electrolytes can include at least one of lithium hexafluorophosphate (LiPF₆), lithium bis(oxalato)borate (LiBOB), lithium oxalyldifluoroborate (LiBF₂C₂O₄), lithium trifluorochloroborate (LiBF₃Cl), LiBF₄, LiPFₓ(CₙF₂ₙ₊₁)₆₋ₓ, LiBF₃Cl, LiBF₄₋ₓ(CₙF₂ₙ₊₁)x, LiSCN, LiB(CO₂)₄, LiASF₆, LiClO₄, LiSO₃CF₃, LiN(SO₂F)₂, LiN(SO₂CF₃)₂, LiN (SO₂C₂F₅)₂, LiN(SO₂F)₂, and LiBF₃Rf.

In another aspect, a battery electrolyte mixture includes one or more lithium salt electrolytes and one or more sulfones. The mixture also includes one or more ionic liquids.

Implementations can optionally include one or more of the following features. The mixture can also include one or more additives. The one or more additives can include one or more molecular additives. The one or more additives can include one or more molecular additives. For example, the one or more molecular additives can include a range of 0.1 to 10wt % of at least one of vinylene carbonate (VC), propanesultone (PS), ethylene sulfite (ES), propylene sulfite, fluoroethylene sulfite (FES), [alpha]-bromo-[gamma]-butyrolactone, methyl chloroformate, t-butylene carbonate, 12-crown˜4, carbon dioxide (CO₂), sulfur dioxide (SO₂), sulfur trioxide (SO₃), acid anhydrides, reaction products of carbon disulfide and lithium, and polysulfide.

The one or more sulfones can include a sulfone with general structure of R1-SO2-R2. R1 and R2 are different in length and can include at least one of a linear alkyl group having 1 to 7 carbon atoms, a branched alkyl group having 1 to 7 carbon atoms, a partially fluorinated linear alkyl group having 1 to 7 carbon atoms, a partially fluorinated branched alkyl group having 1 to 7 carbon atoms, a fully fluorinated linear alkyl group having 1 to 7 carbon atoms, a fully fluorinated branched alkyl group having 1 to 7 carbon atoms, a linear oxygen containing alkyl group having 1 to 7 carbon atoms, a branched oxygen containing alkyl group having 1 to 7 carbon atoms, a partially fluorinated linear oxygen containing alkyl group having 1 to 7 carbon atoms, a partially fluorinated branched oxygen containing alkyl group having 1 to 7 carbon atoms, a fully fluorinated linear oxygen containing alkyl group having 1 to 7 carbon atoms, a fully fluorinated branched oxygen containing alkyl group having 1 to 7 carbon atoms.

The one or more additives can include one or more ionic additives. The one or more ionic additives can include a range of 0.1 to 10wt % of at least one of lithium bis(oxalato)borate (LiBOB), lithium oxalyldifluoroborate (LiBF₂C₂O₄), and lithium trifluorochloroborate (LiBF₃Cl). The one or more ionic liquids can include a tetraalkylammonium based ionic liquid.

The one or more ionic liquids can include an ionic liquid having an anion that includes at least one of BF₄, BF₂C₂O₄, BOB—, BF₃Cl, PF₆, CF₃SO₃, (CF₃SO₂)₂N, (CF₃CF₂SO₂)₂N, (FSO₂)₂N⁻ and R_{f}BF₃⁻. Also, the one or more ionic liquids can include an ionic liquid having a cation selected from a group including pyrrolidinium, piperidinium, and imidazolium.

In another aspect, one or more lithium salt electrolytes are mixed with one or more sulfones. A cycling performance of the mixture is improved by enhancing formation of a solid electrolyte interface.

Implementations can optionally include one or more of the following features. Enhancing the formation of a solid electrolyte interface can include adding one or more additives to the mixture. Adding the one or more additives can include adding one or more ionic additives. Adding the one or more additives can include adding one or more molecular additives. Adding one or more molecular additives can include adding in a range of 0.1 to 10wt % at least one of propanesultone (PS), vinylene carbonate (VC), ethylene sulfite (ES), propylene sulfite, fluoroethylene sulfite (FES), [alpha]-bromo-[gamma]-butyrolactone, methyl chloroformate, t-butylene carbonate, 12-crown˜4, carbon dioxide (CO₂), sulfur dioxide (SO₂), sulfur trioxide (SO₃), acid anhydrides, reaction products of carbon disulfide and lithium, and polysulfide.

Also, mixing the one or more lithium salt electrolytes with one or more sulfones can include mixing lithium hexafluorophosphate (LiPF₆) with the one or more sulfones. Adding the one or more additives can include mixing the one or more ionic additives with the one or more sulfones. Mixing the one or more lithium additives with one or more sulfones can include mixing at least one of lithium bis(oxalato)borate (LiBOB), lithium oxalyldifluoroborate (LiBF₂C₂O₄), and lithium trifluorochloroborate (LiBF₃Cl) with the one or more sulfones.

Also, adding one or more additives can include adding one or more ionic additives. Adding one or more ionic additives can include mixing LiBOB or lithium oxalyldifluoroborate (LiBF₂C₂O₄) or lithium trifluorochloroborate (LiBF₃Cl) with LiPF₆ or other lithium salts with the one or more sulfones. Further, mixing the one or more lithium salt electrolytes with one or more sulfones can include mixing the one or more lithium salt electrolytes with a partially fluorinated or perfluorinated sulfone.

In another aspect, a molar ratio of one or more sulfones and an ionic liquid that includes one of tetraalkylammonium, pyrrolidinium, piperidinium, and imidazolium based ionic liquids is determined to obtain a eutectic mixture with a melting point near or lower than room temperature.

Implementations can optionally include one or more of the following features. The molar ratio can be determined of one or more sulfones that includes high melting point sulfones. Determining the molar ratio can include mixing the ionic liquid based on at least one of tetraalkylammonium, pyrrolidinium, piperidinium, and imidazolium with the one or more high melting point sulfones in a suitable molar ratio in order to get a eutectic mixture. Determining the molar ratio can further include mixing the ionic liquid based on one of tetraalkylammonium, pyrrolidinium, piperidinium, and imidazolium with a partially fluorinated or perfluorinated sulfone. Also, more or more additives can be added to the mixture to support lithium cation intercalation/deintercalation. Adding the one or more additives includes adding a wt % in a range of 0.1 to 10 wt % of at least one of vinylene carbonate, propanesultone, ethylene sulfite (ES), propylene sulfite, fluoroethylene sulfite (FES), [alpha]-bromo-[gamma]-butyrolactone, methyl chloroformate, t-butylene carbonate, 12-crown˜4, carbon dioxide (CO₂), sulfur dioxide (SO₂), sulfur trioxide (SO₃), acid anhydrides, reaction products of carbon disulfide and lithium, and polysulfide to support lithium cation intercalation/deintercalation. Also, determining the molar ratio of one or more sulfones can include determining a molar ratio of one or more high melting point sulfones.

The subject matter described in this specification potentially can provide one or more of the following advantages. By using additives, the cycling performance of sulfone based electrolytes can be enhanced. In addition, a combination of conventional sulfones and tetraalkyl ammonium based ionic liquid can be used to increase the ionic conductivity of the ionic liquid. Further, one or more additives can be added to the sulfone-ionic liquid mixture to cycle the cells based on such electrolytes.

The subject matter described in this specification can be implemented as one or more mixtures, methods of making and/or using the one or more mixtures, etc.

### BRIEF DESCRIPTION OF THE DRAWINGS

FIG. 1 illustrates a comparison of a cycling performance of different salt solutions under a current density of 0.115 mA cm⁻².

FIG. 2 illustrates a comparison of a cycling performance of different salt solutions and combinations under different current densities.

FIG. 3 illustrates a comparison of a cycling performance of a reference carbonate solution under different current densities.

FIG. 4 illustrates a comparison of a cycling performance of a reference carbonate solution under different current densities.

FIGS. 5a, 5b and 5c illustrate a comparison of a cycling performance of a 1.0M LiPF₆/ethylmethoxyethyl sulfone (EMES), solution with different amounts of VC as an additive that cycled under different current densities.

FIG. 6 illustrates a cycling performance of a 1.0M LiPF₆/methoxyethylmethylsulfone (MEMS) solution with 2 wt % VC as an additive that cycled under different current densities.

FIG. 7 illustrates a cycling performance of a 1.0M LiPF₆/MEMS solution with 2 wt % PS as an additive that cycled under different current densities.

FIG. 8 illustrates a cycling performance of a 1.0M LiPF₆/MEMS solution with 2 wt % VC and 2 wt % PS as additives that cycled under different current densities.

FIG. 9 illustrates a comparison of discharge capacity of a 1.0M LiPF₆/MEMS solution with different additives of 2 wt % that cycled under different current densities.

FIG. 10 illustrates a cycling performance of a 1.0M LiBOB/MEMS solution with 2 wt % VC as additive that cycled under different current densities.

FIG. 11 is a process flow diagram of a process for enhancing a cycling performance of a sulfone based electrolyte mixture.

FIG. 12 illustrates differential thermal analysis (DTA) plots of different mixing ratios of N1112TFSI and DMS.

FIG. 13 illustrates DTA plots of different mixing ratios of N1112TFSI and MEMS as stated in the figure.

FIG. 14 illustrates DTA plots of different mixing ratios of N1113TFSI and EMS.

FIG. 15 illustrates DTA plots of different mixing ratios of N1113TFSI and MEMS as stated in the figure.

FIG. 16 illustrates DTA plots of different mixing ratios of 1114TFSI and EMS as stated in the figure.

FIG. 17 illustrates DTA plots of different mixing ratios of 1114TFSI and MEMS as stated in the figure.

FIG. 18 illustrates an electrochemical window for 1.0M LiTFSI/N1113TFSI-EMS (40-60 in mole) with Pt as working electrode and Li metal as counter and reference electrode.

FIG. 19 illustrates an electrochemical window for 1.0M LiTFSI/N1112TFSI-EMES (40-60 in mole) with Pt as working electrode and Li metal as counter and reference electrode.

FIG. 20 illustrates an electrochemical window for 1.0M LiTFSI/N1113TFSI-DMS (60-40 in mole) with Pt as working electrode and Li metal as counter and reference electrode.

FIG. 21 illustrates an electrochemical window for 1.0M LiTFSI/N1111TFSI-EMES (20-80 in mole) with Pt as working electrode and Li metal as counter and reference electrode.

FIG. 22 illustrates a first charge/discharge capacity of 1.0M LiTFSI/N1111TFSI-EMES (20-80, in mole) with 3wt % VC as an additive under different current densities.

FIG. 23 illustrates a cycling test of 1.0M LiTFSI/N1111TFSI-EMES (20-80, in mole) with 3 wt % VC as an additive under a current density of 0.23 mA cm⁻².

FIG. 24 illustrates a cycling test of 1.0M LiTFSI/N1114TFSI-DMS (60-40, in mole) with 5 wt % VC as an additive under a current density of 0.23 mA cm⁻².

FIG. 25 illustrates a cycling test of 1.0M LiTFSI/N1112TFSI-EMES (40-60, in mole) with 5 wt % VC as an additive under a current density of 0.23 mA cm⁻².

FIG. 26 illustrates a process flow diagram of a process for improving an ionic conductivity of a sulfone based electrolyte mixture.

Like reference symbols and designations in the various drawings indicate like elements.

### DETAILED DESCRIPTION

Techniques and electrolyte compositions are described for generating and/or enhancing rechargeable lithium batteries using non-aqueous electrolyte solution. In one aspect, additives can be used to improve the cycling performance of sulfone based electrolytes. For example, additives such as molecular additives and ionic additives can be used.

A sulfone is a chemical compound that contains a sulfonyl functional group attached to two carbon atoms. Sulfones can generally be divided into two types: the aromatic sulfones and the aliphatic sulfones. The aliphatic sulfones can also be divided into two types-the cyclic (commonly referred to as sulfolanes) and non-cyclic. The non-cyclic aliphatic sulfones form a potentially-attractive group of organic solvents that present a high chemical and thermal stability. The sulfur atom is double bonded to two oxygen atoms. The general structural formula for a non-cyclic sulfone is (R₁SO₂R₂) with R1 and R2 being two alkyl groups. At least one of the two alkyl groups is oxygen-containing alkyl group. In some implementations. The R₁ group is a linear or branched alkyl or partially or fully fluorinated linear or branched alkyl group having 1 to 7 carbon atoms. The R₂ group, which is different in formulation than the R₁ group, is a linear or branched or partially or fully fluorinated linear or branched oxygen containing alkyl group having 1 to 7 carbon atoms.

The R₁ alkyl group can include at least one of: methyl (—CH₃); ethyl (—CH₂CH₃); n-propyl (—CH₂CH₂CH₃); n-butyl (—CH₂CH₂CH₂CH₃); n-pentyl (—CH₂CH₂CH₂CH₂CH₃); n-hexyl (—CH₂CH₂CH₂CH₂CH₂CH₃); n-heptyl (⁻CH₂CH₂CH₂CH₂CH₂CH₂CH₃); iso-propyl (—CH(CH₃)₂); iso-butyl (—CH₂CH(CH₃)₂); sec-butyl (—CH(CH₃)CH₂CH₃); tert-butyl (—C(CH₃)₃); iso-pentyl (—CH₂CH₂CH(CH₃)₂); trifluoromethyl (—CF₃); 2,2,2-trifluoroethyl (—CH₂CF₃); 1,1-difluoroethyl (—CF₂CH₃); perfluoroethyl (—CF₂CF₃); 3,3,3-trifluoro-n-propyl (—CH₂CH₂CF₃); 2,2-difluoro-n-propyl (—CH₂CF₂CH₃); 1,1-difluoro-n-propyl (—CF₂CH₂CH₃); 1,1,3,3,3-pentafluoro-n-propyl (—CF₂CH₂CF₃); 2,2,3,3,3-pentafluoro-n-propyl (—CH₂CF₂CF₃); perfluoro-n-propyl (—CF₂CF₂CF₃); perfluoro-n-butyl (—CF₂CF₂CF₂CF₃); perfluoro-n-pentyl (—CF₂CF₂CF₂CF₂CF₃); perfluoro-n-hexyl (—CF₂CF₂CF₂CF₂CF₂CF₃); perfluoro-n-heptyl (—CF₂CF₂CF₂CF₂CF₂CF₂CF₃); —CF(CH₃)₂; —CH (CH₃)CF₃; —CF(CF₃)₂; —CH(CF₃)₂; —CH₂CF(CH₃)₂; —CF₂CH (CH₃)₂; —CH₂CH (CH₃)CF₃; —CH₂CH(CF₃)₂; —CF₂CF (CF₃)₂; —C(CF₃)₃.

The R₂ alkyl group can include at least one of: —CH₂OCH₃; —CF₂OCH₃; —CF₂OCF₃; —CH₂CH₂OCH₃; —CH₂CF₂OCH₃; —CF₂CH₂OCH₃; —CF₂CF₂OCH₃; —CF₂CF₂OCF₃; —CF₂CH₂OCF₃; —CH₂CF₂OCF₃; —CH₂CH₂OCF₃; —CHFCF₂OCF₂H; —CF₂CF₂OCF (CF₃)₂; —CF₂CH₂OCF (CF₃)₂; —CH₂CF₂OCF(CF₃)₂; CH₂CH₂OCF(CF₃)₂; CF₂CF₂OC (CF₃)₃; —CF₂CH₂OC (CF₃)₃; CH₂CF₂OC(CF₃)₃; —CH₂CH₂OC(CF₃)₃; —CH₂CH₂OCH₂CH₃; —CH₂CH₂OCH₂CF₃; —CH₂CH₂OCF₂CH₃; —CH₂CH₂OCF₂CF₃; —CH₂CF₂OCH₂CH₃; —CH₂CF₂OCF₂CH₃; —CH₂CF₂OCH₂CF₃; —CH₂CF₂OCF₂CF₃; —CF₂CH₂OCH₂CH₃; —CF₂CH₂OCF₂CH₃; —CF₂CH₂OCH₂CF₃; —CF₂CH₂OCF₂CF₃; —CF₂CF₂OCH₂CH₃; —CF₂CF₂OCF₂CH₃; —CF₂CF₂OCH₂CF₃; —CF₂CF₂OCF₂CF₃; —CF₂CF₂CF₂OCH₃; —CF₂CF₂CH₂OCH₃; —CF₂CH₂CF₂OCH₃; —CH₂CF₂CF₂OCH₃; —CH₂CF₂CH₂OCH₃; —CH₂CH₂CF₂OCH₃; —CF₂CH₂CH₂OCH₃; —CH₂CH₂CH₂OCH₃; —CF₂CF₂CF₂OCF₃; —CF₂CF₂CH₂OCF₃; —CF₂CH₂CF₂OCF₃; —CH₂CF₂CF₂OCF₃; —CH₂CH₂CF₂OCF₃; —CH₂CF₂CH₂OCF₃; —CF₂CH₂CH₂OCF₃; —CH₂CH₂CH₂CH₂OCH₃; —CH₂CH₂CH₂CH₂CH₂OCH₃; —CH₂CH₂CH₂CH₂CH₂CH₂OCH₃; —CH₂CH₂OCH₂CH₂OCH₃; CH₂CH₂OCH₂CH₂OCH₂CH₂OCH₃.

Sulfones can possess high anodic oxidation voltage (>5.5 v), and thus provide a wide electrochemical window for practical applications. However, sulfones can be inefficient in forming a solid electrolyte interface (SEI), which is beneficial for a battery electrolyte's long cycle life. To enhance the formation of SEI, various techniques can be applied.

Liquid electrolytes in Li-ion batteries consist of solid lithium-salt electrolytes, such as Lithium Hexafluorophosphate (LiPF₆), lithium tetrafluoroborate (LiBF₄), or lithium perchlorate (LiClO₄), and organic solvents, such as alkyl carbonates. In some implementations, ionic electrolyte salt can be selected from a group that includes MClO₄, MBF₃Cl, MBF₂C₂O₄, MPF₆, MPFₓ(CₙF₂ₙ₊₁)₆₋ₓ, MBF₄, MASF₆, MBF₄₋ₓ(CₙF₂ₙ₊₁)ₓ, MSCN, MB(CO₂)₄, MN(SO₂CF₃)₂, MN(SO₂C₂F₅)₂, MN(SO₂F)₂ and MSO₃CF₃, where “M” is lithium or sodium or potassium, or any mixture thereof. A liquid electrolyte can conduct Lithium (Li) ions, which can act as a carrier between the cathode and the anode when a battery passes an electric current through an external circuit. However, solid electrolytes and organic solvents may be easily decomposed on anodes during charging, and thus preventing battery activation.

When appropriate organic solvents are used as electrolytes, such electrolytes can decompose and form a solid electrolyte interface during the first charge. The solid electrolyte interface can be electrically insulating and high Li-ion conducting. The solid electrolyte interface can help to prevent decomposition of the electrolyte after a second charge. For example, ethylene carbonate can decompose at a relatively high voltage (0.7 V vs. Li), and forms a dense and stable solid electrolyte interface.

Oxygen-Containing Sulfones with Mixed Salt and Additives

The inefficiency of sulfones in forming the SEI can be remedied using the various techniques described in this specification. In one example, an additive can be used to enhance SEI formation. The additive used to benefit the formation of SEI can include molecular additives, such as PS and VC and ionic additives, such as LiBOB, lithium oxalyldifluoroborate (LiBF₂C₂O₄) and lithium trifluorochloroborate (LiBF₃Cl).

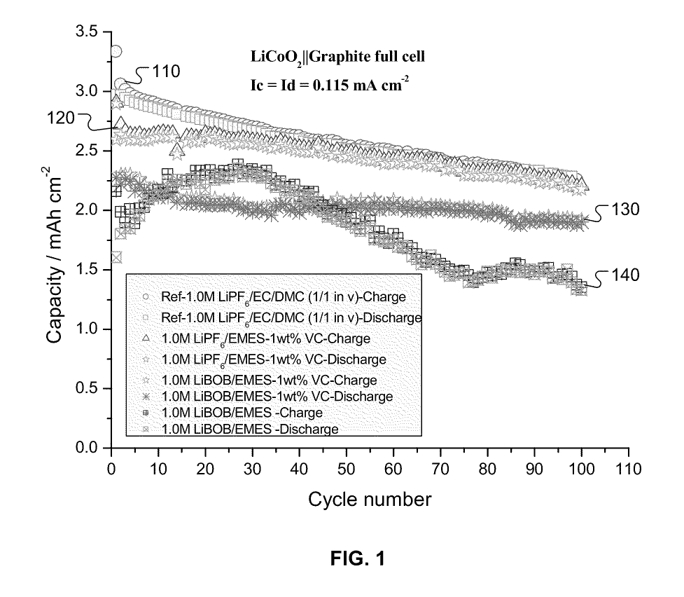

FIG. 1 shows the results of implementing an additive to a mixture of a Lithium salt electrolyte and sulfone. For this and other implementations, the amount of additive used can vary. In particular, the weight (wt) percentage (%) of the additive (VC, PS, etc.) used can include a range from 0.1 to 10 wt %. For example, when 1 weight % (wt %) of VC (120) is added to a LiPF6 based sulfone electrolyte, the charge/discharge capacity of the battery cell is shown to be comparable with that of a reference cell generated based on pure carbonate mixture (110) of ethylene carbonate (EC) and diemthyl carbonate (DMC) (1/1 in volume).

For illustrative purposes, implementations are described with respect to molecular additives, such as PS and VC as the additives used. However, other appropriate additives can be similarly implemented. For example, appropriate additives can include molecular additives, such as ethylene sulfite (ES), propylene sulfite, fluoroethylene sulfite (FES), [alpha]-bromo-[gamma]-butyrolactone, methyl chloroformate, t-butylene carbonate, 12-crown˜4, carbon dioxide (CO₂), sulfur dioxide (SO₂), sulfur trioxide (SO₃), acid anhydrides, reaction products of carbon disulfide and lithium, polysulfide, and other inorganic additives

Also, ionic additives such as lithium bis(oxalato)borate (LiBOB), lithium oxalyldifluoroborate (LiBF₂C₂O₄), lithium trifluorochloroborate (LiBF₃Cl) can be used. For example, lithium bis(oxalato)borate (LiBOB), which is known to form SEI effectively, is implemented as an ionic additive to generate various sulfone electrolyte solutions 130, 140. As shown in FIG. 1, with a mixture 140 of only LiBOB and ethylmethoxyethyl sulfone (EMES), the charge/discharge capacity of the battery cell increases at first, starts to decrease, and eventually stabilizes. However, with addition of 1 wt % VC 130, the charge/discharge capacity of the battery cell quickly stabilizes after an initial SEI formation period.

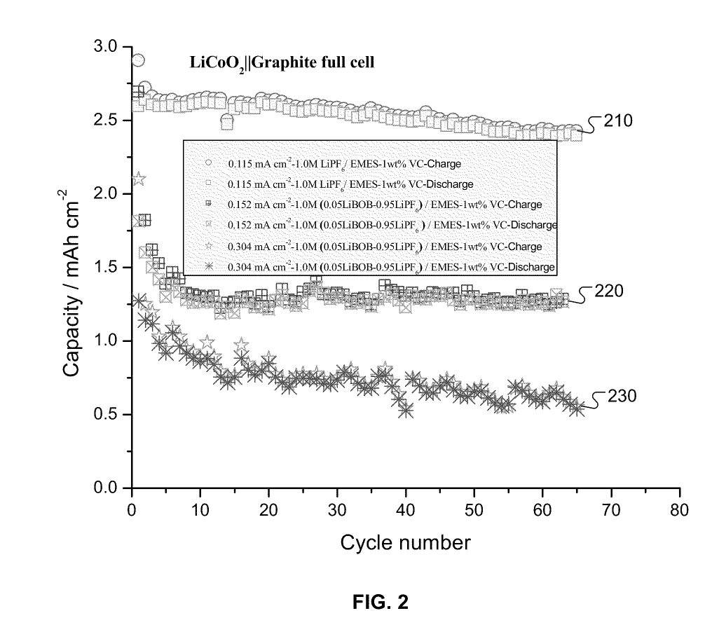

In some implementations, a lithium salt mixture of 5% LiBOB and 95% LiPF₆ is used, with 1 wt % VC as the molecular additive. FIG. 2 illustrates a comparison of the cycling performance of different salt solutions and combinations under different current densities as specified in the figure. Note that there is no special formation cycle for these battery cells, and all of the battery cells are cycled directly under the specified current densities. In such mixtures 220, 230, the charge/discharge capacity of the battery cell quickly stabilizes in similar fashion as a mixture (210) of LiPF₆ and EMES and 1 wt % VC.

The mixed salt of LiBOB—LiPF₆ is provided for illustrative purposes only, and other mixtures can be implemented. For example, mixtures can include, LiBOB—LiBF₄, LiBOB—LiTFSI etc.

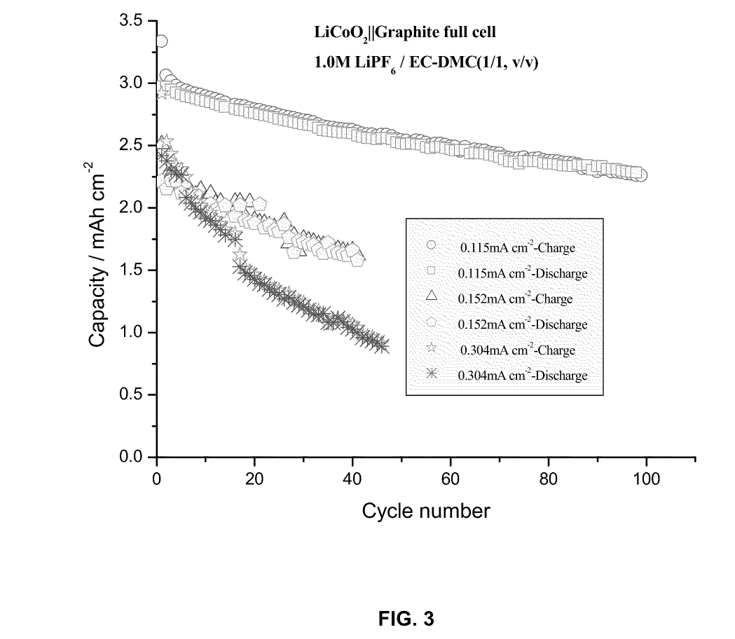

FIG. 3 illustrates another comparison of the cycling performance of the reference carbonate solution under different current densities as specified in the figure. Note that there is no special formation cycle for these cells, and all the cells are cycled directly under the specified current densities.

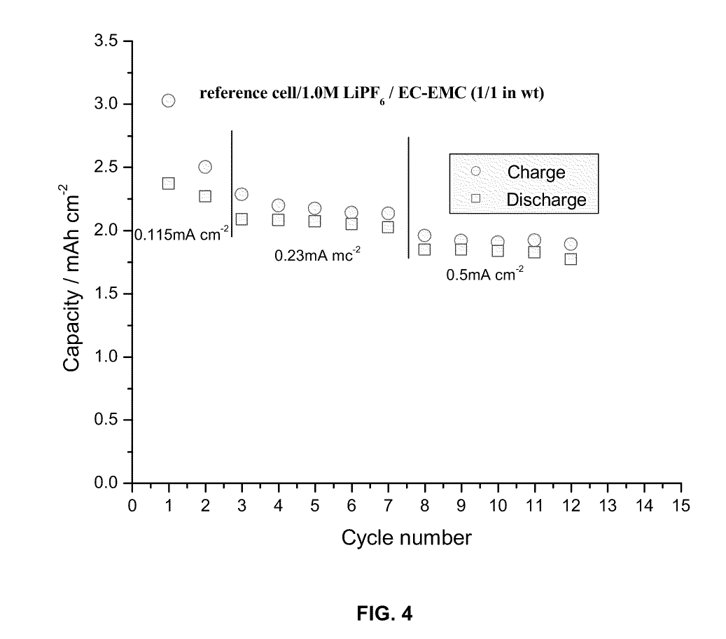

FIG. 4 illustrates yet another comparison of the cycling performance of the reference carbonate solution under different current densities as specified in the figure. Note that the first two cycles were treated as formation cycle (0.115 mA cm⁻²=C/20 rate). Also, 0.23 mA cm⁻²=C/10 rate and 0.5 mA cm⁻²=C/4.6 rate.

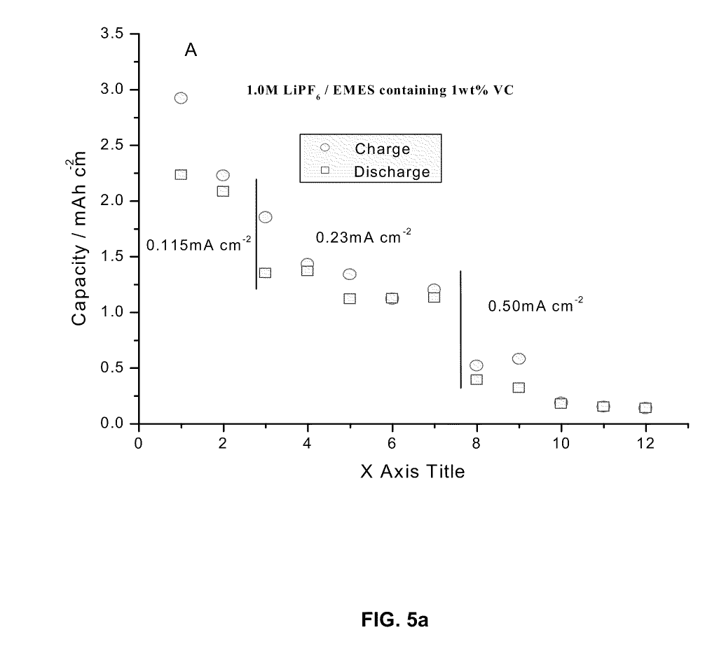

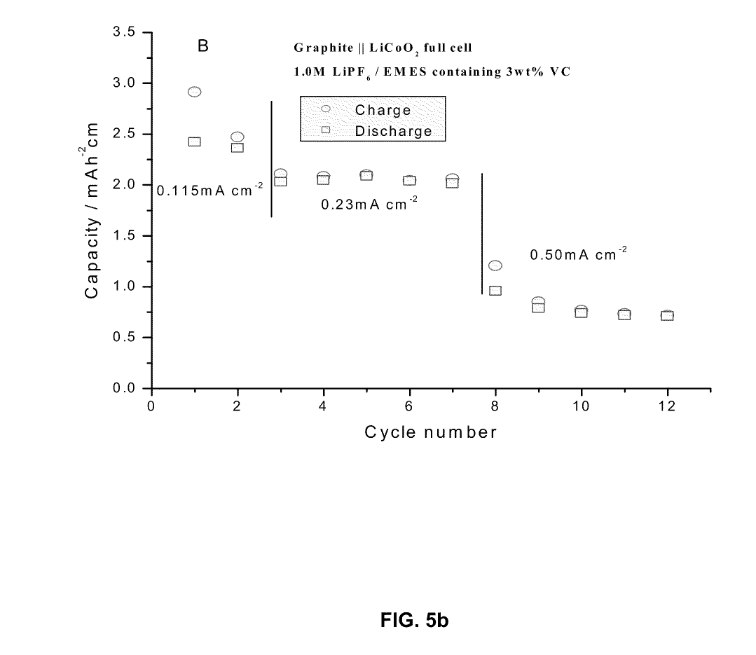

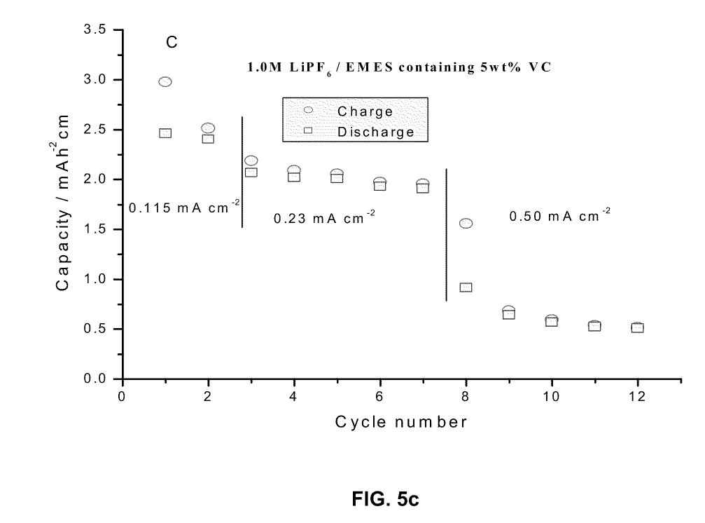

FIGS. 5a, 5b and 5c illustrate comparisons of the cycling performance of the 1.0M LiPF₆/EMES solution with different wt % amount of VC as additive (FIG. 5a: 1 wt % VC; FIG. 5b: 3 wt % VC; FIG. 5c: 5 wt % VC) that cycled under different current densities. Note that the first two cycles are treated as the formation cycle (0.115 mA cm⁻²=C/20 rate). Also, 0.23 mA cm⁻²=C/10 rate and 0.5 mA cm⁻²=C/4.6 rate.

The effect of an additive (e.g., VC) in providing a high rate performance of sulfone based electrolyte solutions (e.g., LiPF₆/EMES solution) saturates beyond an optimal wt % range of 1 to 3 wt %. For example, the effect of VC increases as the amount added reaches 2 or 3 wt % of VC. However, the effect of VC saturates as higher amounts (e.g., greater than 2 or 3 wt %) of VC are used as the additive.

The poor higher rate performance of EMES compared with that reference solution is at least due to the high viscosity of EMES solution. In such instances, partially fluorinate or perfluorinated sulfones are used to alleviate the performance deficiency.

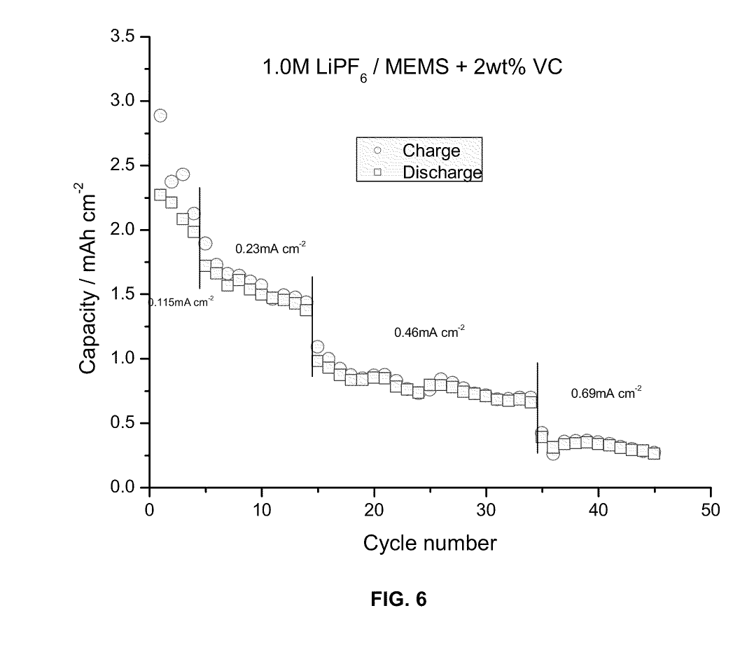

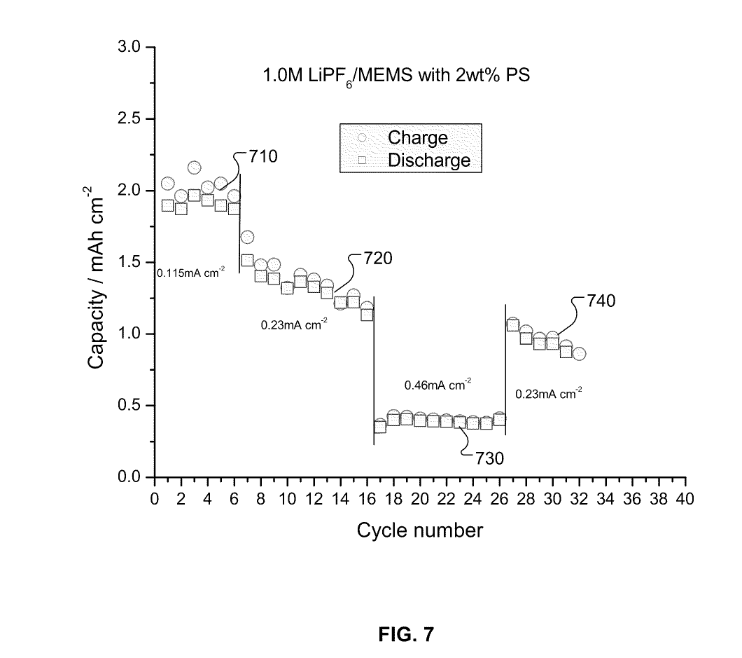

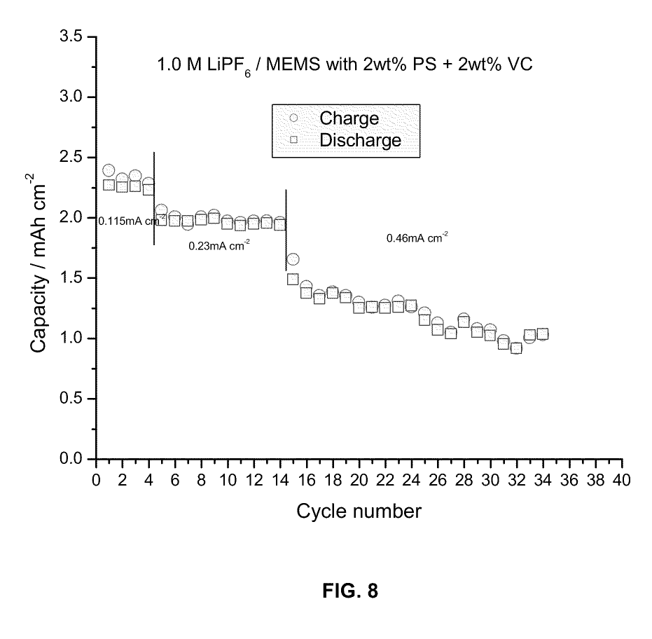

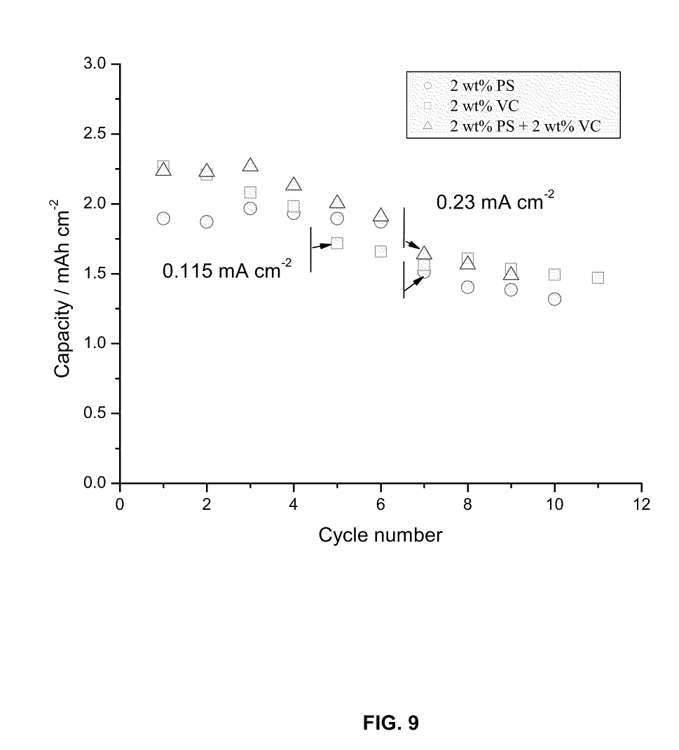

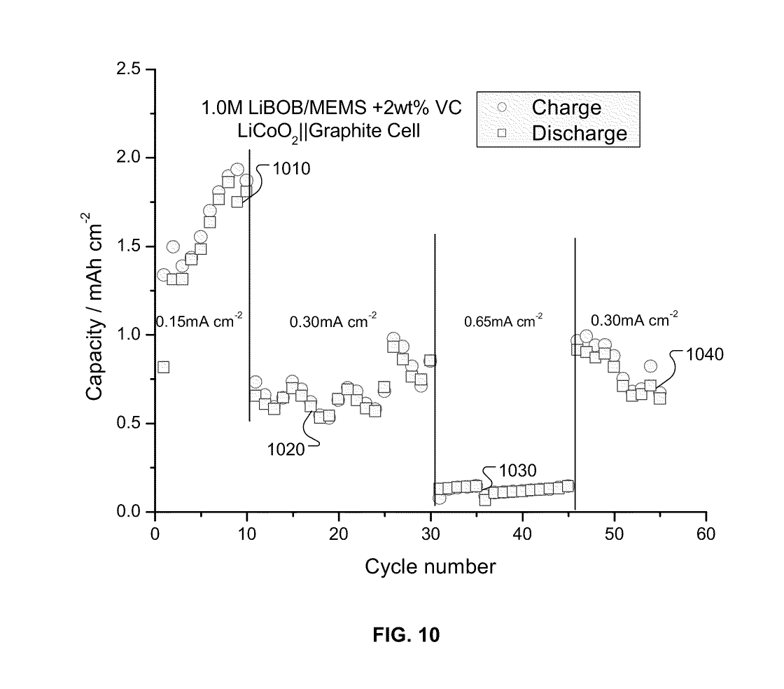

FIG. 6 shows the cycling performance of a 1.0M LiPF₆/MEMS solution with 2 wt % VC as additive that cycled under different current densities as specified in the figure. FIG. 7 shows the cycling performance of the 1.0M LiPF₆/MEMS solution with 2wt % PS as additive that cycled under different current densities as specified in the figure. FIG. 8 shows the cycling performance of a 1.0M LiPF₆/MEMS solution with 2 wt % VC and 2 wt % PS as additives that cycled under different current densities as specified in the figure. FIG. 9 shows a comparison of the discharge capacity of a 1.0M LiPF₆/MEMS solution with 2 wt % of different additives that cycled under different current densities as specified in the figure. Note that for the VC additive, the cell started from cycle 5 and cycled under current density of 0.23 mA cm⁻² while the other two started from cycle 7. FIG. 10 shows the cycling performance of a 1.0M LiBOB/MEMS solution with 2wt % VC as additive that cycled under different current densities as specified in the figure.

The effect of viscosity on the charge/discharge capacity is shown in FIGS. 7 and 10. In FIG. 7, the charge/discharge capacity is determined under various current densities including 0.115 mAcm⁻² 710, 0.23 mAcm⁻² 720, 740, and 0.46 mAcm⁻² 730. When the current density is increased from 0.23 mAcm⁻² 720 to 0.46 mAcm⁻² 730 and reduced back to 0.23 mAcm⁻² 740, the capacity at 740 recovers to the previous current density level 720. In FIG. 10, the charge/discharge capacity is determined under various current densities including 0.15 mAcm⁻² 1010, 0.30 mAcm⁻² 1020, 1040, and 0.65 mAcm⁻² 1030. When the current density is increased from 0.30 mAcm⁻² 1020 to 0.65 mAcm⁻² 1030 and reduced back to 0.30 mAcm⁻² 1040, the capacity at 1040 recovers to the previous current density level 1020.

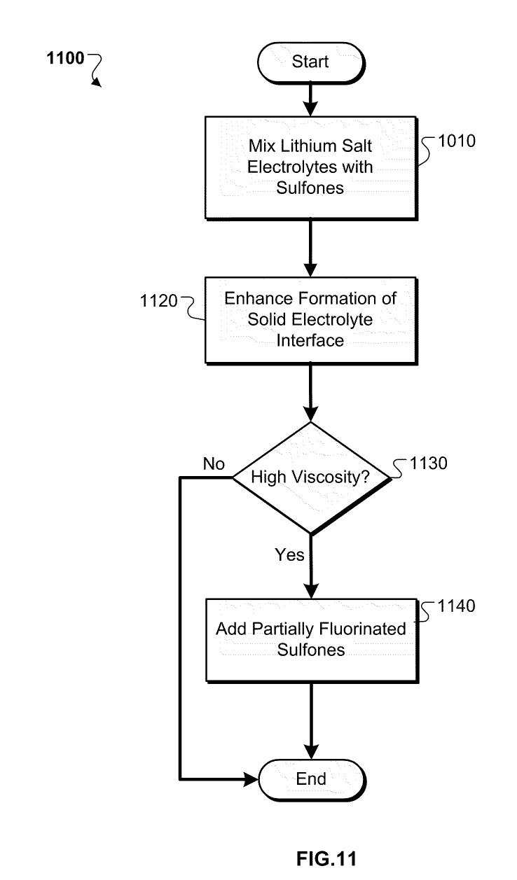

FIG. 11 is a process flow diagram of a process 1100 for enhancing a cycling performance of a battery cell. One or more lithium salt electrolytes are mixed 1110 with one or more sulfones. A cycling performance of the mixture is improved by enhancing 1120 the formation of a solid electrolyte interface. Enhancing the formation of a solid electrolyte interface can include adding one or more additives to the mixture. Adding the one or more additives can include adding at least one of PS and VC. Adding the at least one of PS and VC can include adding a range of 1 to 3 wt % VC. Alternatively, adding the at least one of PS and VC can include adding a range of 1 to 3 wt % PS. Also, mixing the one or more lithium salt electrolytes with one or more sulfones can include mixing lithium hexafluorophosphate (LiPF6) with the one or more sulfones. Mixing the one or more lithium salt electrolytes with one or more sulfones can include mixing an ionic additive, such as lithium bis(oxalato)borate (LiBOB) or lithium oxalyldifluoroborate (LiBF₂C₂O₄) or lithium trifluorochloroborate (LiBF₃Cl) with other lithium salts with the one or more sulfones.

Alternatively, mixing the one or more lithium salt electrolytes with one or more sulfones includes mixing LiBOB with LiPF₆ and with the one or more sulfones. Further, a determination 1130 is made whether to compensate for the effect of the high viscosity of EMES solution. To compensate for the effect of the high viscosity, one or more lithium salt electrolytes are mixed 1140 with one or more partially fluorinated sulfones. Mixing the one or more lithium salt electrolytes with one or more sulfones can further include mixing the one or more lithium salt electrolytes with an ethylmethoxyethyl sulfone (EMES).

### Mixture of Solfone and Ionic Liquid

In another aspect, conventional sulfones can be combined with ionic liquids, such as tetraalkyl ammonium based ionic liquids to increase the ionic conductivity of the ionic liquid. The sulfones used in this aspect having a general structure of R1-SO2-R2, where R1 and R2 are different in length and can be selected from either a linear or branched alkyl or partially or fully fluorinated linear or branched alkyl group having 1 to 7 carbon atoms, or a linear or branched or partially or fully fluorinated linear or branched oxygen containing alkyl group having 1 to 7 carbon atoms. Further, one or more additives can be added to a mixture of sulfone and tetraalkylammonium based ionic liquids to generate electrolyte solutions. Tetraalkylammonium based ionic liquids can be used as a solvent to dissolve lithium salts, and the resultant electrolyte solution may have a wide electrochemical window for high voltage applications. The solution can have a higher than average viscosity and thus limit its use for high rate high voltage applications.

By mixing the electrolyte solution, formed from tetraalkylammonium based ionic liquids and lithium salts, with sulfone, the ionic conductivity of the mixture is improved relative to the pure ionic liquid. The improvement in ionic conductivity is obtained without sacrificing the advantage of wide electrochemical window for high voltage applications. As mentioned with respect to the pure sulfone based electrolyte solutions, the use of partially fluorinated or perfluorinated sulfones can enhance this benefit (higher ionic conductivity and thus high rate tolerance) further than non-fluorinated sulfones.

The various tetraalkylammonium ionic liquids used in this specification are defined as follows. The letter “N” is used to represent ammonium and the number following “N” is used to define the length of the alkane chains. For example, number 1 is used for methyl and 2 for ethyl, etc. Also the anion of bis(trifluoromethanesulfonyl)imide is represented by TFSI. In some implementations, the anion part of the ionic liquid can include others such as BF₃Cl⁻, BF₂C₂O₄⁻, BOB⁻, BF₄⁻, PF₆⁻, CF₃SO₃⁻, (CF₃CF₂SO₂)₂N⁻, (CF₃SO₂)₂N⁻, (FSO₂)₂N⁻, R_{f}BF₃⁻, etc. The cation part of the ionic liquid can include cations such as pyrrolidinium, piperidinium, imidazolium, etc.

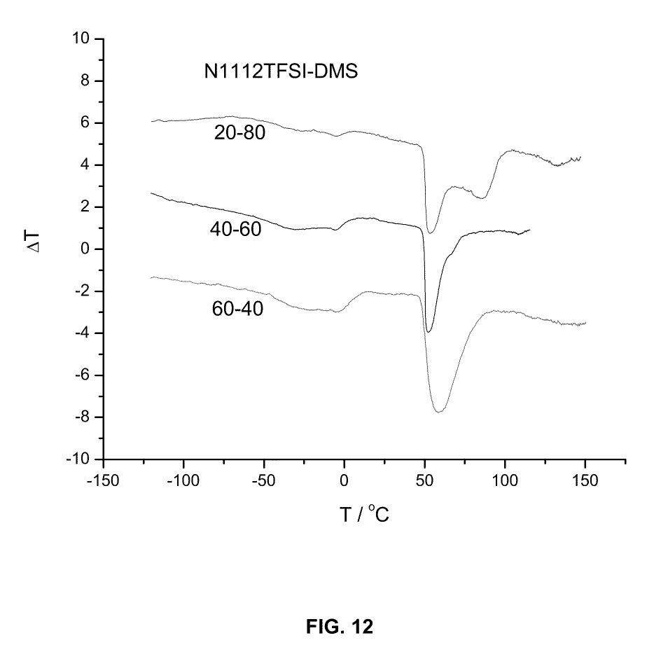

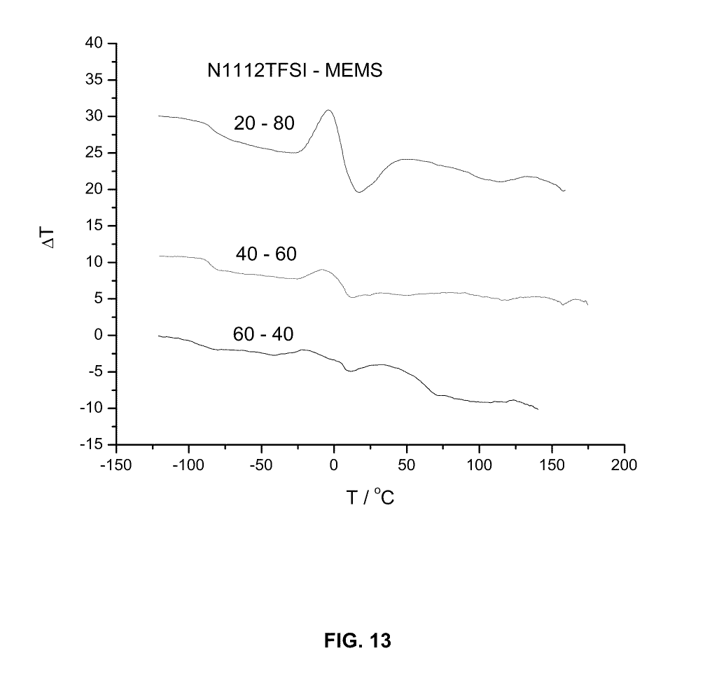

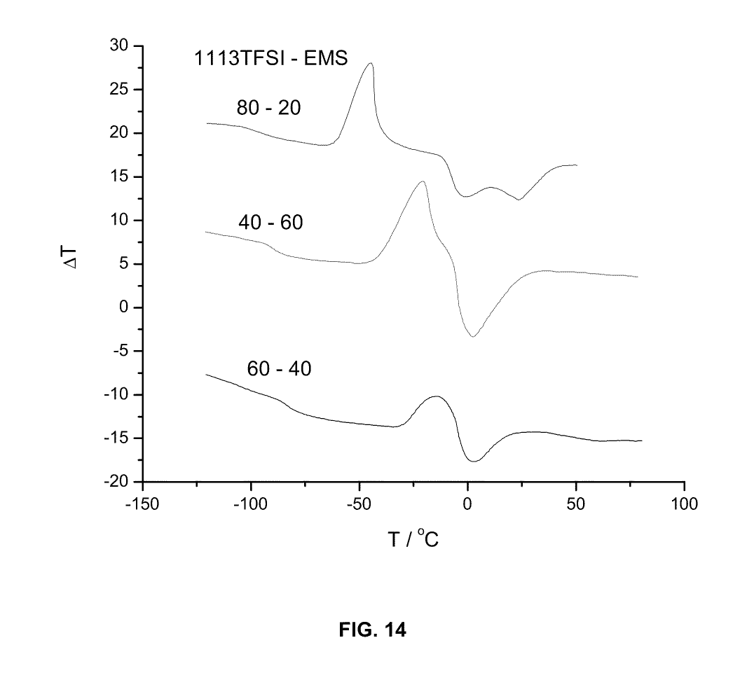

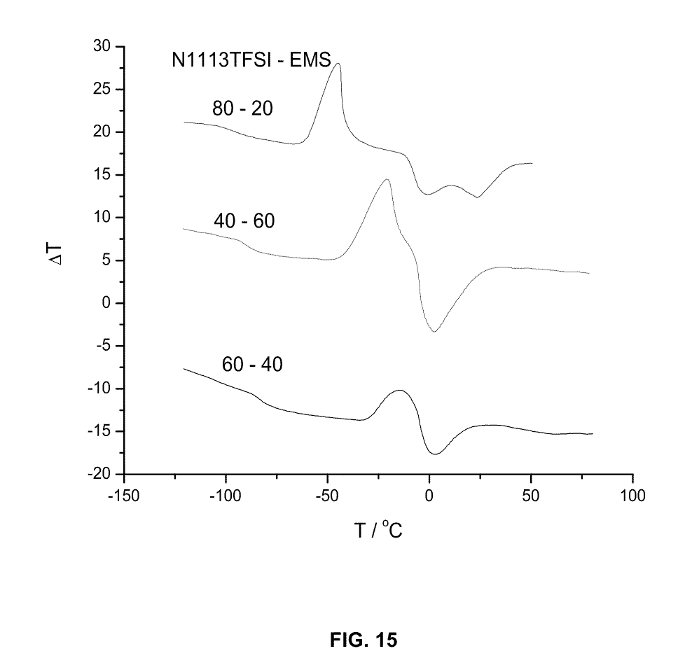

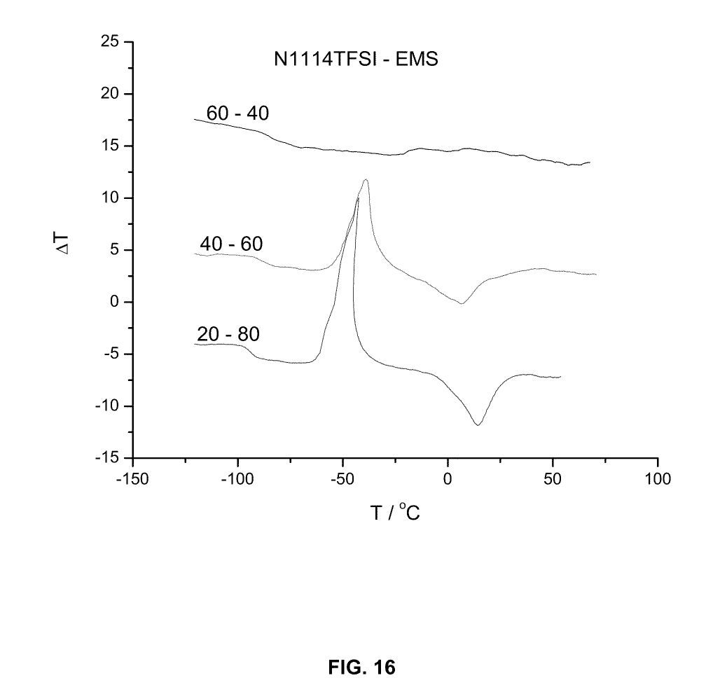

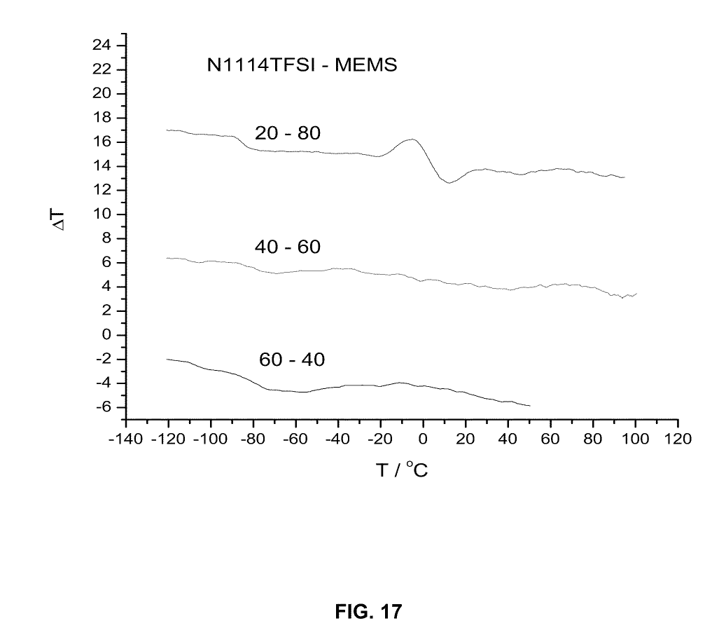

By mixing high melting point sulfone with tetraalkylammonium ionic liquid, a eutectic mixture with much lower melting point is obtained. FIG. 12 illustrates DTA plots for different mixing ratios of trimethylethylammonium bis(trifluoromethanesulfonyl)imide (N1112TFSI) and dimethylsulfone (DMS) as stated in the figure. As shown in FIG. 12, trimethylethylammonium bis(trifluoromethanesulfonyl)imide (N1112TFSI, melting point (m.p.) 105° C.) can be mixed with dimethylsulfone (DMS, m.p. 110° C.) in a molar ration of 2:3 to obtain a eutectic mixture with a melting point of 57° C. Using the same principle, different combinations of sulfones and tetraalkylammonium ionic liquids can be obtained as shown in FIGS. 13, 14, 15, 16 and 17 to push the melting point well below room temperature. Such melting points (below room temperature) are ideal for practical low temperature applications. FIG. 13 illustrates DTA plots of different mixing ratios of N1112TFSI and MEMS as stated in the figure. FIG. 14 illustrates DTA plots of different mixing ratios of N1113TFSI and EMS as stated in the figure. FIG. 15 illustrates DTA plots of different mixing ratios of N1113TFSI and MEMS as stated in the figure. FIG. 16 illustrates DTA plots of different mixing ratios of 1114TFSI and EMS as stated in the figure. FIG. 17 illustrates DTA plots of different mixing ratios of 1114TFSI and MEMS as stated in the figure.

In addition, when sulfone is added to tetraalkylammonium ionic liquid, the ionic conductivity increases. Since the solution of 1.0M LiTFSI/N1112TFSI crystallizes at room temperature, a 0.5 M solution is used to compare with the same salt concentration of the binary mixtures. As shown in Table 1, the addition of 60 molar % of ethylmethyl sulfone increases the ionic conductivity almost 2.5 folds. Table 2 shows the ionic conductivities of 1.0M LiTFSI solutions of different mixtures of sulfones and tetraalkylammonium ionic liquids.

TABLE 1
Comparison of ionic conductivity of 0.5M LiTFSI solutions of pure
ionic liquid of N1113TFSI and mixture of N1113TFSI and EMS

| | | N1113TFSI-EMS (40-60 |
|---|---|---|
| System | N1113TFSI | by mole) |
| σ•(m S cm⁻¹) | 1.43 | 3.34 |

TABLE 2
Room temperature ionic conductivities
of 1.0M LiTFSI of different mixtures

| Systems | σ•(m S cm⁻¹) |
|---|---|
| N1113TFSI-DMS (60-40 | 2.38 |
| by mole) | |
| N1114TFSI-DMS ((60-40 | 1.94 |
| by mole) | |
| N1113TFSI-EMS (40-60 | 2.77 |
| by mole) | |
| N1114TFSI-EMS (40-60 | 2.15 |
| by mole) | |
| N1112TFSI-EMES (40-60 | 2.70 |
| by mole) | |
| N1113TFSI-EMES (40-60 | 2.03 |
| by mole) | |
| N1114TFSI-EMES (40-60 | 1.58 |
| by mole) | |

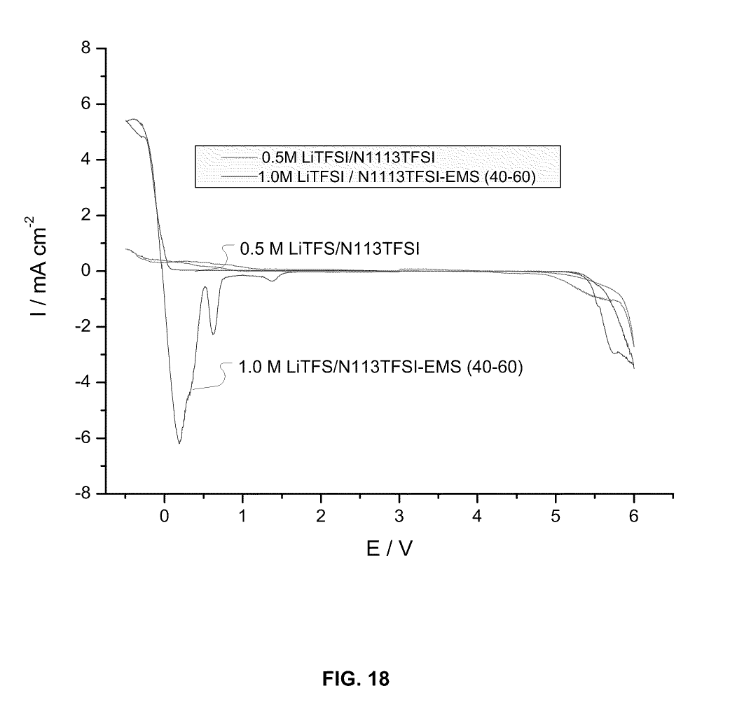

In some implementations, sulfone is added to ionic liquids to increase the ionic conductivity without sacrificing the electrochemical window. For example, sulfone can be added to tetraalkylammonium ionic liquids. FIG. 18 shows a comparison of the electrochemical window between a pure ionic liquid and a mixture of sulfone and ionic liquid. In particular, FIG. 18 illustrates a comparison of the electrochemical window between a mixture of 1.0 M LiTFSI/N1113TFSI-EMS (40-60 in mole) and 0.5 M LiTFSI/N1113TFSI. The electrochemical window measurements in this and other figures can be obtained by using Platinum (Pt) as the working electrode and Li metal as the counter and reference electrode.

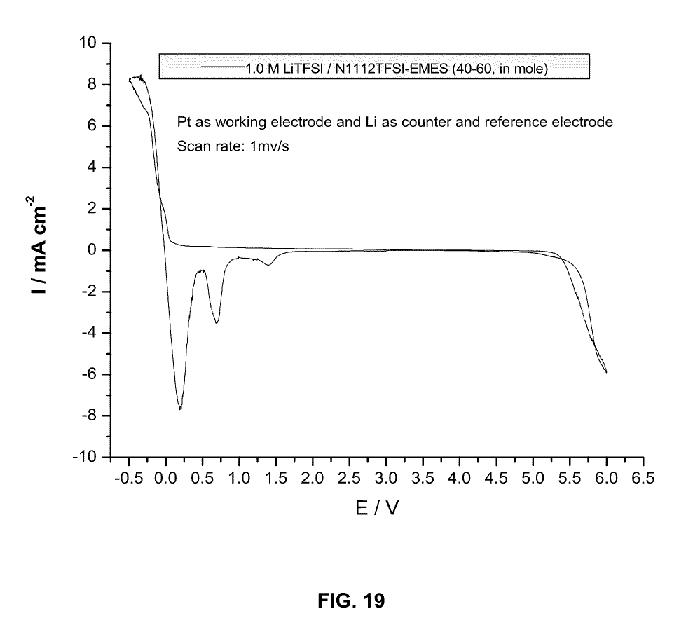

Compared to a pure ionic liquid, the mixture of sulfone and ionic liquid exhibits better anodic stability and well behaved lithium deposition and stripping. FIGS. 19, 20 and 21 illustrate exemplary wide electrochemical windows (>5.2v) of different sulfone-ionic liquid mixtures. In particular, mixtures of various sulfones and tetraalkyl ammonium ionic liquids are implemented.

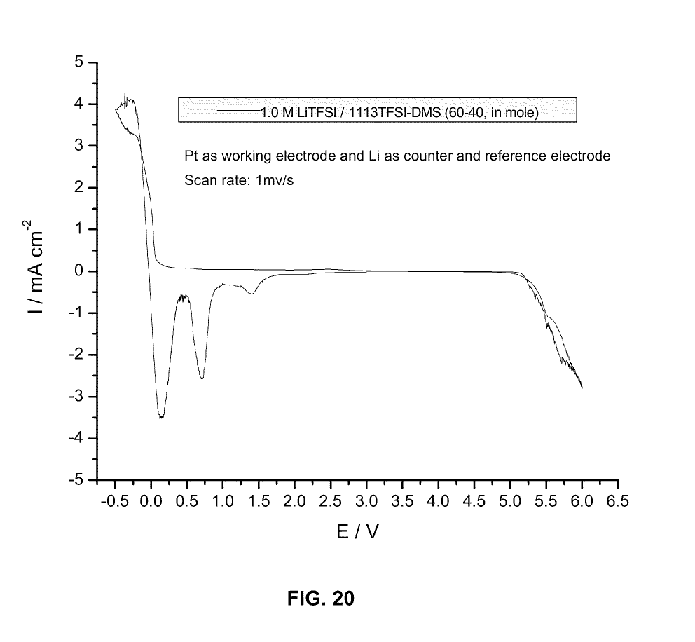

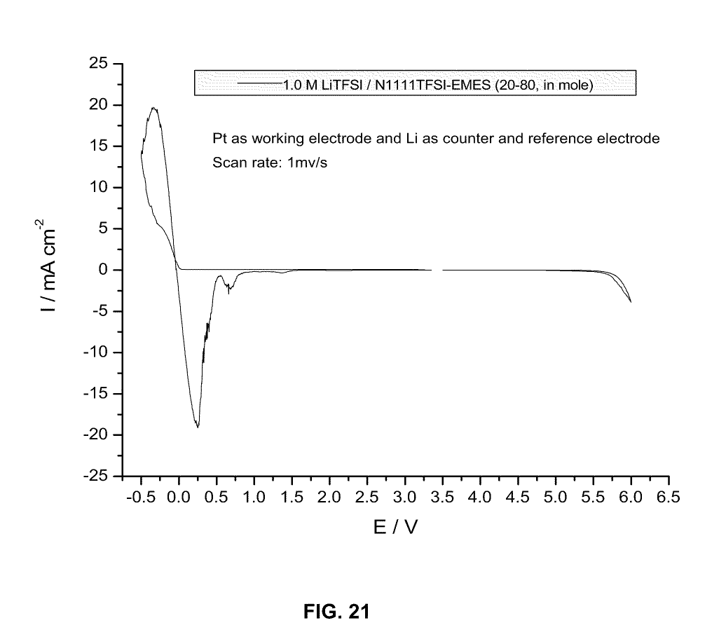

FIG. 19 shows an exemplary electrochemical window for a mixture of 1.0M LiTFSI/N1112TFSI-EMES (40-60 in mole) with Pt as working electrode and Li metal as counter and reference electrode. FIG. 20 shows an exemplary electrochemical window for a mixture of 1.0M LiTFSI/N1113TFSI-DMS (60-40 in mole) measured with a Pt working electrode and a Li metal counter and reference electrode. FIG. 21 shows the electrochemical window for a mixture of 1.0M LiTFSI/N1111TFSI-EMES (20-80 in mole) measured with a Pt working electrode and a Li metal counter and reference electrode.

While examples are described in this and other implementations with LiTFSI as the salt mixture described in the sulfone-ionic liquid mixture, other lithium salts can be used. For example, lithium salts include MClO₄, MPF₆, MPFₓCₙF₂ₙ₊₁)₆₋ₓ, MBF₄, MBF₄₋ₓ (CₙF₂ₙ₊₁)ₓ, MAsF₆, MSCN, MB(CO₂)₄, MN(SO₂CF₃)₂, MBF₃Cl, MBF₂C₂O₄, MBOB, MN(SO₂C₂F₅)₂, MN(SO₂F)₂ and MSO₃CF₃, where “M” is lithium or sodium or potassium, or any mixture thereof.

In some implementations, one or more additives such as VC are added to a mixture of sulfones and tetralkylammonium ionic liquids to support lithium cation intercalation/deintercalation. The amount of additive used can vary from a range of 0.1 wt % to 10 wt %. Further, in addition to PS and VC, other additives can be implemented. Additives can include molecular additives, such as vinylene carbonate (VC), propanesultone (PS), ethylene sulfite (ES), propylene sulfite, fluoroethylene sulfite (FES), [alpha]-bromo-[gamma]-butyrolactone, methyl chloroformate, t-butylene carbonate, 12-crown˜4, carbon dioxide (CO₂), sulfur dioxide (SO₂), sulfur trioxide (SO₃), acid anhydrides, reaction products of carbon disulfide and lithium, polysulfide, and other inorganic additives.

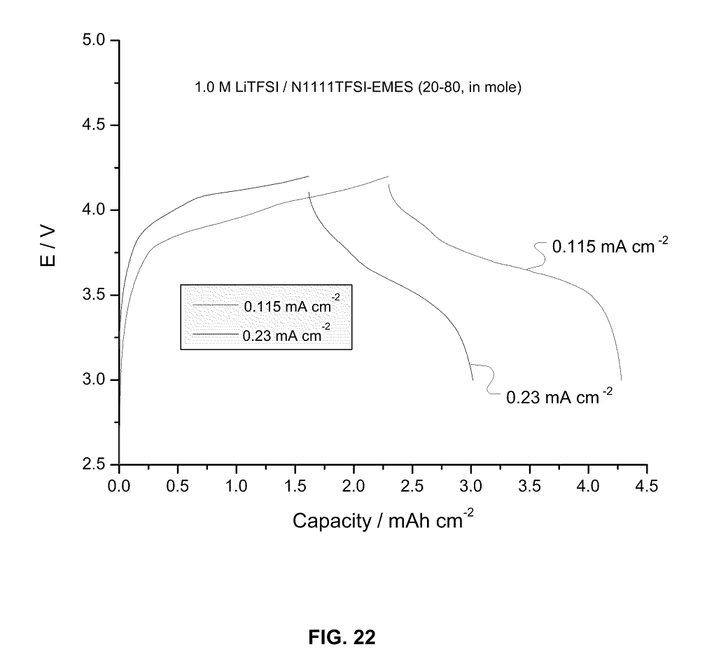

For example, FIG. 22 shows the charge/discharge capacity of a 1.0M LiTFSI/1111TFSI-EMES (20-80, in mole) mixture with 3 wt % VC added. The charge/discharge capacity is measured under different current density. The reduced high-rate charge/discharge capacities can be directly related to the relative high viscosity of the mixture when compared to commercial mixtures of carbonates electrolytes.

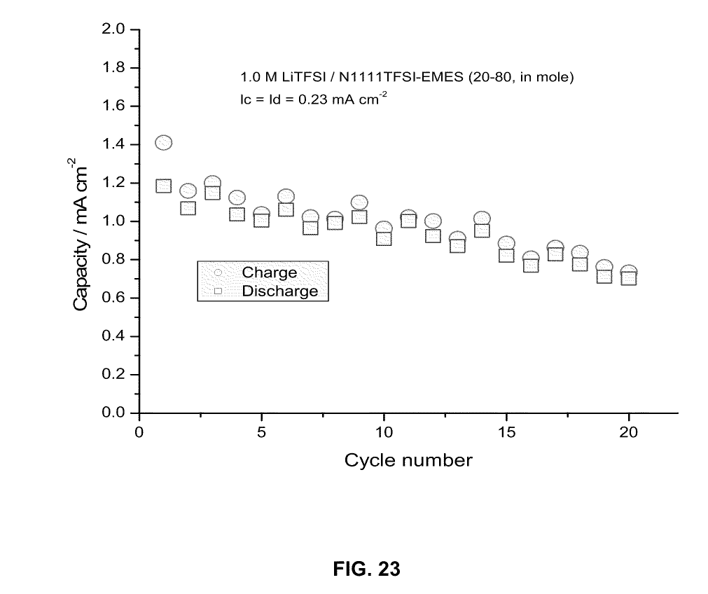

FIGS. 23, 24 and 25 show the cycling performances of different mixtures of sulfones and tetraalkylammonium ionic liquids. The cycling performance of these mixtures can be improved by carefully monitoring and tuning the mixture content. For example, the water content of the mixture, the condition of the cell sealing, etc. can be monitored.

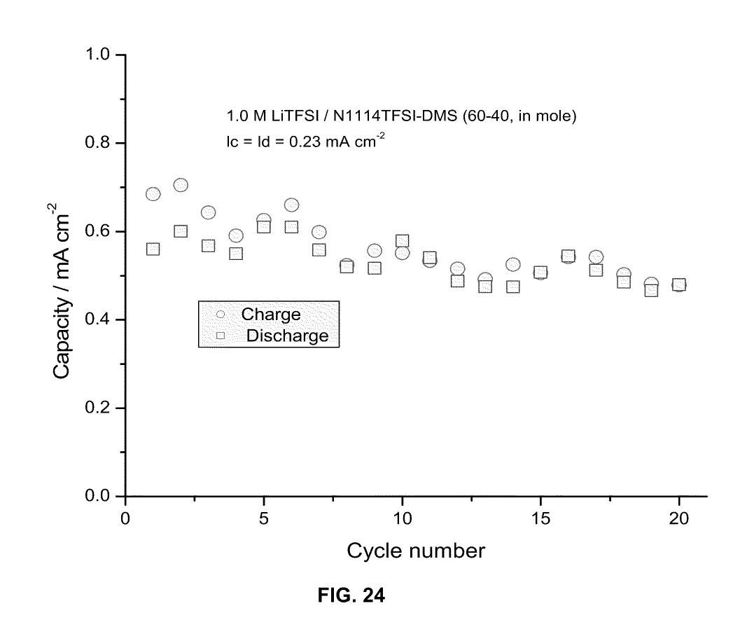

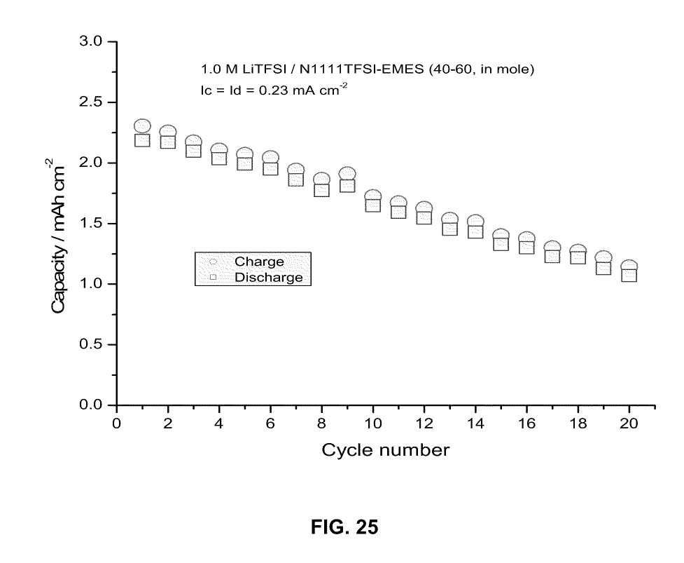

FIG. 23 illustrates the cycling test for a mixture of 1.0M LiTFSI/N1111TFSI-EMES (20-80, in mole) with 3 wt % VC under the current density of 0.23 mA cm⁻². FIG. 24 shows the cycling test for a mixture of 1.0M LiTFSI/N1114TFSI-DMS (60-40, in mole) with 5 wt % VC under the current density of 0.23 mA cm⁻². FIG. 25 shows the cycling test for a mixture of 1.0M LiTFSI/N1112TFSI-EMES (40-60, in mole) with 5 wt % VC under the current density of 0.23 mA cm⁻².

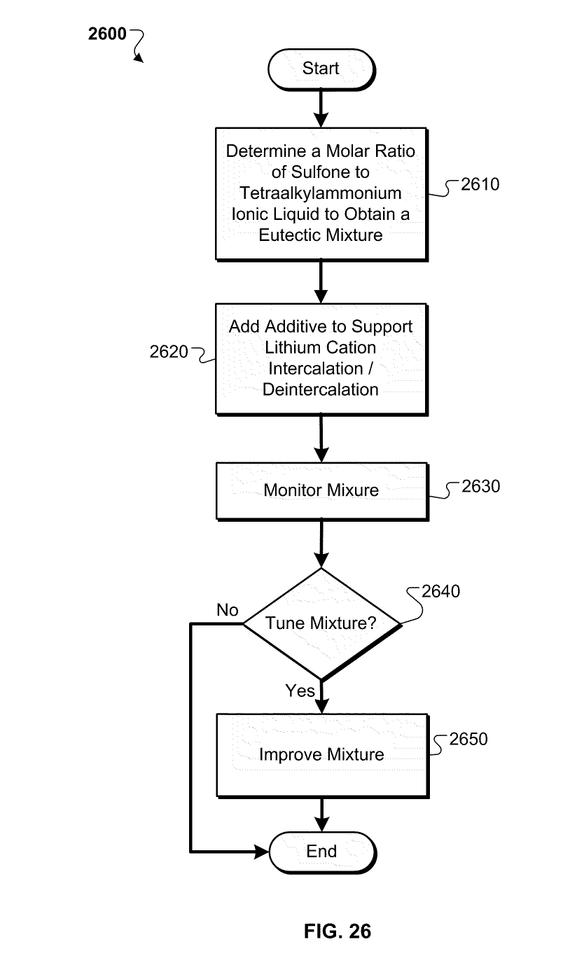

FIG. 26 is a process flow diagram of a process 2600 for improving the ionic conductivity of a sulfone based electrolyte mixture. A molar ratio of one or more high melting point sulfones and a tetraalkylammonium ionic liquid is determined 2610 to obtain a eutectic mixture with a melting point lower than room temperature. Determining the molar ratio can include mixing the tetraalkylammonium ionic liquid with the one or more high melting point sulfones in a 2 to 3 molar ratio. Determining the molar ratio can further include mixing the tetraalkylammonium ionic liquid with a partially fluorinated sulfone. Determining the molar ratio can also include mixing trimethylethylammonium bis(trifluoromethanesulfonyl)imide (N1112TFSI) with dimethylsulfone (DMS). One or more additives are added 1620 to the mixture to support lithium cation intercalation/deintercalation. Adding the one or more additives includes adding a wt % of VC to the mixture. The performance of the battery cell (mixture) can be improved 2650 by carefully tuning 2640 the mixture by monitoring 2630 the water content of the mixture and the condition of the cell sealing etc.

While this specification contains many specifics, these should not be construed as limitations on the scope of any invention or of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results.

Additional technical features are described in Appendix A, which is part of the specification of this application.

Only a few implementations and examples are described and other implementations, enhancements and variations can be made based on what is described and illustrated in this application.

What is claimed is:

1. A battery material comprising:
one or more ionic electrolyte salts;
a non-aqueous electrolyte solvent including one or more sulfones; and
one or more additives.

2. The battery material of claim 1, wherein the non-aqueous electrolyte solvent comprises one or more non-symmetrical, non-cyclic sulfones of a general formula: R1-SO2-R2, wherein the R1 group comprises one of a linear alkyl group having 1 to 7 carbon atoms, a branched alkyl group having 1 to 7 carbon atoms, a partially fluorinated linear alkyl group having 1 to 7 carbon atoms, a partially fluorinated branched alkyl group having 1 to 7 carbon atoms, fully fluorinated linear alkyl group having 1 to 7 carbon atoms, a fully fluorinated branched alkyl group having 1 to 7 carbon atoms, and the R2 group, which is different in formulation than the R1 group, comprises one of a linear oxygen containing alkyl group having 1 to 7 carbon atoms a branched oxygen containing alkyl group having 1 to 7 carbon atoms, a partially fluorinated linear oxygen containing alkyl group having 1 to 7 carbon atoms, a partially fluorinated branched oxygen containing alkyl group having 1 to 7 carbon atoms, a fully fluorinated linear oxygen containing alkyl group having 1 to 7 carbon atoms, a fully fluorinated branched oxygen containing alkyl group having 1 to 7 carbon atoms.

3. The material of claim 1, wherein the one or more additives comprise one or more molecular additives.

4. The material of claim 3, wherein the one or more additives comprise a range of 0.1 to 10wt % of the one or more molecular additives.

5. The material of claim 4, wherein the one or more molecular additives comprise at least one of vinylene carbonate (VC), propanesultone (PS), ethylene sulfite (ES), propylene sulfite, fluoroethylene sulfite (FES), [alpha]-bromo-[gamma]-butyrolactone, methyl chloroformate, t-butylene carbonate, 12-crown˜4, carbon dioxide (CO₂), sulfur dioxide (SO₂), sulfur trioxide (SO₃), acid anhydrides, reaction products of carbon disulfide and lithium, and polysulfide.

6. The material of claim 1, wherein the one or more ionic electrolyte salts comprise at least one of lithium hexafluorophosphate (LiPF₆), LiPFₓ(CₙF₂ₙ₊₁)₆₋ₓ, LiClO₄, LiBF₂C₂O₄, LiBF₃Cl, LiBF₄, LiBF₄₋ₓ(CₙF₂ₙ₊₁)x, LiAsF₆, LiSCN, LiB(CO₂)₄, LiN(SO₂F)₂, LiN(SO₂CF₃)₂, LiN(SO₂C₂F₅)₂, LiN(SO₂F)₂, and LiSO₃CF₃.

7. The material of claim 1, wherein the one or more additives comprise one or more ionic additives.

8. The material of claim 7, wherein the one or more additives comprise a range of 0.1 to 10 wt % of the one or more ionic additives.

9. The material of claim 8, wherein the one or more ionic additives comprise lithium bis(oxalato)borate (LiBOB) or lithium oxalyldifluoroborate (LiBF₂C₂O₄) or lithium trifluorochloroborate (LiBF₃Cl).

10. A battery electrolyte mixture comprising:
one or more lithium salt electrolytes;
one or more sulfones; and
one or more ionic liquids.

11. The electrolyte mixture of claim 10, further comprising:
one or more additives.

12. The material of claim 11, wherein the one or more additives comprise one or more molecular additives.

13. The electrolyte mixture of claim 12, wherein the one or more molecular additives comprise a range of 0.1 to 10 wt % of at least one of vinylene carbonate, propanesultone, ethylene sulfite (ES), propylene sulfite, fluoroethylene sulfite (FES), [alpha]-bromo-[gamma]-butyrolactone, methyl chloroformate, t-butylene carbonate, 12-crown˜4, carbon dioxide (CO₂), sulfur dioxide (SO₂), sulfur trioxide (SO₃), acid anhydrides, reaction products of carbon disulfide and lithium, and polysulfide.

14. The mixture of claim 10, wherein the one or more sulfones comprise a sulfone with a general structure of R1-SO2-R2, wherein R1 and R2 are different in length and R1 and R2 comprise at least one of a linear alkyl group having 1 to 7 carbon atoms, a branched alkyl group having 1 to 7 carbon atoms, a partially fluorinated linear alkyl group having 1 to 7 carbon atoms, a partially fluorinated branched alkyl group having 1 to 7 carbon atoms, a fully fluorinated linear alkyl group having 1 to 7 carbon atoms, a fully fluorinated branched alkyl group having 1 to 7 carbon atoms, a linear oxygen containing alkyl group having 1 to 7 carbon atoms, a branched oxygen containing alkyl group having 1 to 7 carbon atoms, a partially fluorinated linear oxygen containing alkyl group having 1 to 7 carbon atoms, a partially fluorinated branched oxygen containing alkyl group having 1 to 7 carbon atoms, a fully fluorinated linear oxygen containing alkyl group having 1 to 7 carbon atoms, a fully fluorinated branched oxygen containing alkyl group having 1 to 7 carbon atoms.

15. The material of claim 11, wherein the one or more additives comprise one or more ionic additives.

16. The electrolyte mixture of claim 15, wherein the one or more ionic additives comprise a range of 0.1 to 10wt % of at least one of lithium bis(oxalato)borate (LiBOB), lithium oxalyldifluoroborate (LiBF₂C₂O₄), and lithium trifluorochloroborate (LiBF₃Cl).

17. The mixture of claim 10, wherein the one or more ionic liquids comprise a tetraalkylammonium based ionic liquid.

18. The mixture of claim 10, wherein the one or more ionic liquids comprise an ionic liquid having an anion comprising at least one of BF₄⁻, BF₃Cl⁻, BF₂C₂O₄⁻, BOB⁻, PF₆⁻, CF₃SO₃⁻, (CF₃SO₂)₂N⁻, (CF₃CF₂SO₂)₂N⁻, (FSO₂)₂N⁻ and R_{f}BF₃⁻.

19. The mixture of claim 10, herein the one or more ionic liquids comprise an ionic liquid having a cation comprising at least one of pyrrolidinium, piperidinium, and imidazolium.

20. A method comprising:
mixing one or more lithium salt electrolytes with one or more sulfones; and
improving a cycling performance of the mixture by enhancing formation of a solid electrolyte interface.

21. The method of claim 20, wherein enhancing the formation of a solid electrolyte interface comprises adding one or more additives to the mixture.

22. The method of claim 21, wherein adding one or more additives comprises adding one or more ionic additives.

23. The method of claim 21, wherein adding one or more additives comprises adding one or more molecular additives.

24. The method of claim 23, wherein adding the one or more molecular additives comprises adding in a range of 0.1 to 10wt % at least one of propanesultone, vinylene carbonate, ethylene sulfite (ES), propylene sulfite, fluoroethylene sulfite (FES), [alpha]-bromo-[gamma]-butyrolactone, methyl chloroformate, t-butylene carbonate, 12-crown˜4, carbon dioxide (CO₂), sulfur dioxide (SO₂), sulfur trioxide (SO₃), acid anhydrides , reaction products of carbon disulfide and lithium, and polysulfide.

25. The method of claim 20, wherein mixing the one or more lithium salt electrolytes with one or more sulfones comprises mixing at least lithium hexafluorophosphate (LiPF₆) with the one or more sulfones.

26. The method of claim 22, wherein adding the one or more additives comprises mixing the one or more ionic additives with the one or more sulfones.

27. The method of claim 26, wherein mixing the one or more ionic additives with one or more sulfones comprises mixing at least one of lithium bis(oxalato)borate (LiBOB), lithium oxalyldifluoroborate (LiBF₂C₂O₄), and lithium trifluorochloroborate (LiBF₃Cl) with the one or more sulfones.

28. The method of claim 27, further comprising mixing at least one of LiBOB, lithium oxalyldifluoroborate (LiBF₂C₂O₄), and lithium trifluorochloroborate (LiBF₃Cl) with at least one lithium salt comprising LiPF₆ and with the one or more sulfones.

29. The method of claim 20, wherein mixing the one or more lithium salt electrolytes with one or more sulfones comprises mixing the one or more lithium salt electrolytes with a partially fluorinated or perfluorinated sulfone.

30. A method comprising:
determining a molar ratio of one or more sulfones and an ionic liquid comprising at least one of tetraalkylammonium, pyrrolidinium, piperidinium, and imidazolium based ionic liquids to obtain a eutectic mixture with a melting point near or lower than room temperature.

31. The method of claim 30, wherein determining the molar ratio comprises mixing the ionic liquid based at least on one of tetraalkylammonium, pyrrolidinium, piperidinium, and imidazolium with a partially fluorinated or perfluorinated sulfone.

32. The method of claim 30, further comprising adding one or more additives comprises adding a wt % in a range of 0.1 to 10wt % of one or more additives that comprises at least one of vinylene carbonate, propanesultone, ethylene sulfite (ES), propylene sulfite, fluoroethylene sulfite (FES), [alpha]-bromo-[gamma]-butyrolactone, methyl chloroformate, t-butylene carbonate, 12-crown˜4, carbon dioxide (CO₂), sulfur dioxide (SO₂), sulfur trioxide (SO₃), acid anhydrides, reaction products of carbon disulfide and lithium, and polysulfide to the mixture to support lithium cation intercalation/deintercalation.

33. The method of claim 30, wherein determining the molar ratio of one or more sulfones comprises determining a molar ratio of one or more high melting point sulfones.
